(19) United States
(12) Patent Application Publication
(10) Pub. No.: US 2007/0270196 A1
(43) Pub. Date: Nov. 22, 2007

(54) Earphone device with vibration capability

(76) Inventor: Yaz-Tzung Wu, Taipei (TW)

Correspondence Address: RABIN & Berdo, PC, 1101 14TH STREET, NW, SUITE 500, WASHINGTON, DC, 20005, US

(21) Appl. No.: 11/435,748

(22) Filed: May 18, 2006

(51) Int. Cl. H04M 1/00

(52) U.S. Cl. 455/575.2

(57) ABSTRACT

An earphone device with vibration capability is provided. The earphone device can apply to a portable electronic device having a satellite navigation system and is mainly composed of vibration units in the earphone devices. The vibration units can be utilized to realize the vibrations of the earphone device in different manners, according to the incoming call instruction signals and navigation direction instruction signals, thus informing the user of an incoming call and the direction to the destination.

### BACKGROUND

1. Field of Invention

The present invention relates to an earphone device, and in particularly to an earphone device with vibration capability.

2. Related Art

Recently, with the rapid development and progress of science and technology, the computer devices have become an indispensable tool in our daily life. The functions of various portable electronic devices presently available on the market are numerous, so that the positioning guidance function of the Global Positioning System (GPS) and the broadcasting function of the MPEG Audio Player 3 (MP3) may be realized in certain specific electronic devices simultaneously. In this respect, the GPS can be utilized to provide optimized route plans for the people engaged in outdoor activities. Likewise, they may get to their destinations accurately and promptly in an efficient manner, without having to spend too much time searching for the best route to their destination. Meanwhile, the MP3 may be used to provide entertainment and enjoyment to the user while driving a vehicle.

For conventional technology and devices in this respect, refer to the following prior arts published in Taiwan Patent Publication No. M250156 “Portable Navigation Device” published on Nov. 11, 2004; Patent Publication No. 200509001 “System and Method for dynamic Road Navigation” published on Mar. 11, 2005, and Patent Publication No. M278018 “Vehicle Navigation Device” published on Oct. 11, 2005. In summary, in the above-mentioned prior art, the navigation device is installed in moving objects, such as vehicles and portable electronic devices, so that the user may check and look at his/her present position and the suggested route to the destination through a display panel, thus reaching the destination in a swift and efficient manner. In addition, in U.S. Patent Publication No. 2005/0027385 “MP3 player having a wireless earphone communication with a mobile” published on Feb. 3, 2005, the incoming call may be used to generate a ring in an earphone device indicating the arrival of an incoming call, so that it will not be missed by the user.

Though enjoying the benefits and advantages of the above-mentioned prior art, the user still has to pay attention to view the information shown on the display panel, as provided by the GPS, while driving a vehicle, which is not safe. In addition, if there is an incoming call while the user is listening to the MP3 music, the music is stopped by the earphone and switched to a ring tone, indicating there is an incoming call, thus spoiling the fun of the user.

### SUMMARY OF THE INVENTION

According to one aspect on the invention, an earphone device with vibration capability is provided, which can be applied on a portable electronic device having a satellite positioning navigation system, including an earphone device having a pair of vibration units, and is electrically connected to the portable electronic device through a signal transmission line. Upon receiving the incoming call instruction signals from the portable electronic device, the vibration units are activated to generate vibrations in both of the two earphone bodies, thus informing the user of an incoming call. However, upon receiving the navigation direction instruction signal from the portable electronic device, one of the vibration units is activated to generate the vibrations in the earphone body in one of the left and right ears indicating the direction of turning.

Accordingly, it is an object of the present invention to provide an earphone device with vibration capability so that the user does not have to be distracted to view the information of the GPS on the display panel. Meanwhile, on receiving the incoming call, there is no need to interrupt the listening of the MP3 music with the ring reminder.

Another object of the present invention is to provide an earphone device with vibration capability by making use of a wireless transmission module for reminding the user of the incoming call, without being restricted by the necessity of a wire connection.

The features and practice of the preferred embodiments of the present invention will be illustrated below in detail with reference to the drawings.

### BRIEF DESCRIPTION OF THE DRAWINGS

The invention will become more fully understood from the detailed description given below for illustration only, and thus is not limitative of the present invention, wherein:

FIG. 1 is a schematic diagram of the earphone device with vibration capability, connected to a portable electric device through a signal transmission line according to an embodiment of the invention;

FIG. 2 is a block diagram of the earphone device with vibration capability of the invention;

FIG. 3 is a schematic diagram of the earphone device with vibration capability according to another embodiment of the invention;

FIG. 4 is a block diagram of the earphone device with vibration capability according to another embodiment of the invention; and

FIG. 5 is a system flowchart indicating the steps of operation of the earphone device with vibration capability according to one embodiment of the invention.

### DETAILED DESCRIPTION OF THE INVENTION

The purpose, construction, features, and functions of the invention can be appreciated and understood more thoroughly through the following detailed description with reference to the attached drawings.

In the invention, a portable electronic device having a multimedia and satellite navigation system is for example a notebook computer, a personal data assistant (PDA), a GPS navigator, or a cell phone.

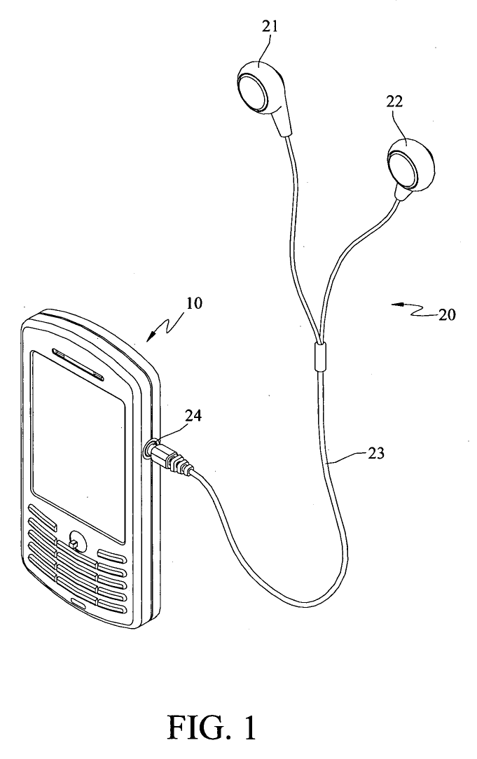

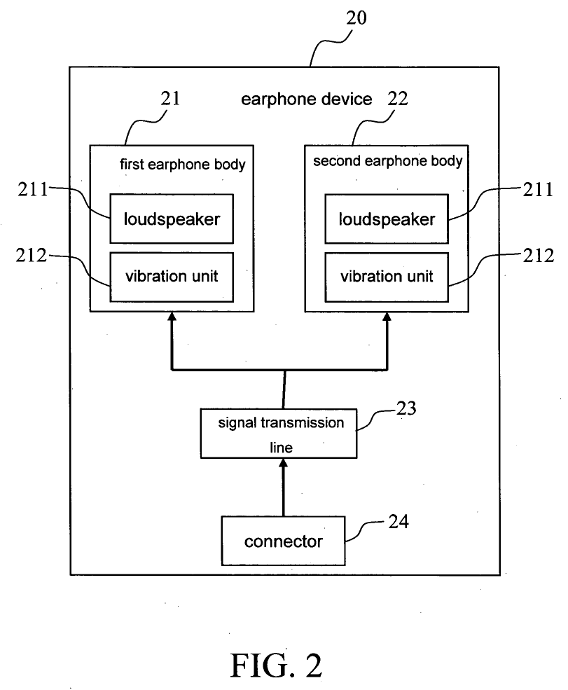

As shown in FIGS. 1 and 2. FIG. 1 is a schematic diagram of the earphone device with vibration capability connected to a portable electronic device through a signal transmission line. FIG. 2 is a block diagram of the earphone device with vibration capability. The earphone device 20 is connected to a portable electronic device 10, having a satellite navigation system, through a signal transmission line, including: a first earphone body 21, composed of a loudspeaker 211, which is used to produce an audio wave according to the audio signals transmitted from the portable electronic device 10, a vibration unit 212, used to vibrate, thus making the earphone device 20 vibrate according to the instruction signals transmitted from the portable electronic device 10; a second earphone body 22, also composed of a loudspeaker 211, which is used to produce an audio wave according to the audio signals transmitted from the portable electronic device 10, a vibration unit 212, used to vibrate, thus making the earphone device 20 vibrate according to the instruction signals transmitted from the portable electronic device 10; a signal transmission line 23, electrically connected to the first earphone body 21 and the second earphone body 22, and used to transmit the signals emitted from the portable electronic device 10, and a connector 24, electrically connected to a signal transmission line 23, and plugged into the socket of the portable electronic device 10.

As shown in FIG. 2, the vibration unit 212 is used to produce vibration, informing the user of the arrival of the incoming call according to the instruction signal transmitted from the portable electronic device 10. Alternatively, the vibration units 212 are used to produce vibrations informing the user to turn in the designated direction such as left or right turns.

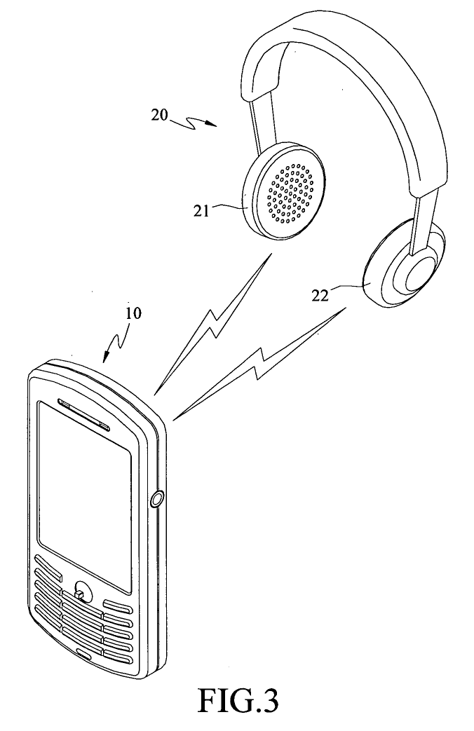

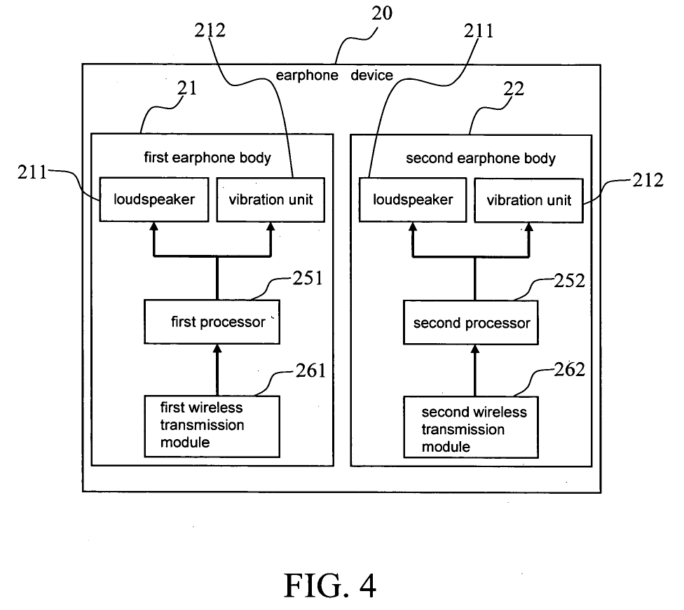

Next, as shown in FIGS. 3 and 4, FIG. 3 is a schematic diagram of the earphone device with vibration capability according to another embodiment of the invention. FIG. 4 is a block diagram of the earphone device with vibration capability according to another embodiment of the invention. In FIG. 3, the earphone device 20 is connected wirelessly to a portable electronic device 10 having a satellite navigation system, including: a first earphone body 21, composed of a loudspeaker 211, which is used to produce an audio wave according to the audio signals transmitted from the portable electronic device 10, a vibration unit 212, used to vibrate, thus making the earphone device 20 vibrate according to the instruction signals transmitted from the portable electronic device 10; a first processor 251, connected electrically to the loudspeaker 211 and the vibration unit 212, and used to receive and transmit signals; a first wireless transmission module 261, electrically connected to the first processor 251, and used to transmit a signal to and from the portable electronic device 10; a second earphone body 22, also composed of a loudspeaker 211, which is used to produce an audio wave according to the audio signals transmitted from the portable electronic device 10; a vibration unit 212, used to vibrate, thus making the earphone device 20 vibrate according to the instruction signals transmitted from the portable electronic device 10; a second processor 252, connected electrically to the loudspeaker 211 and the vibration unit 212, and used to receive and transmit signals; a second wireless transmission module 262, electrically connected to the second processor 252, and used to transmit a signal to and from the portable electronic device 10.

Then, as shown in FIG. 4, it is a block diagram of the earphone device with vibration capability according to another embodiment of the invention. The vibration unit 212 is used to produce vibration, informing the user of an incoming call according to the instruction signal transmitted from the portable electronic device 10. Alternatively, the vibration units 212 can be used to produce vibrations informing the user to turn in the designated direction such as left or right turns.

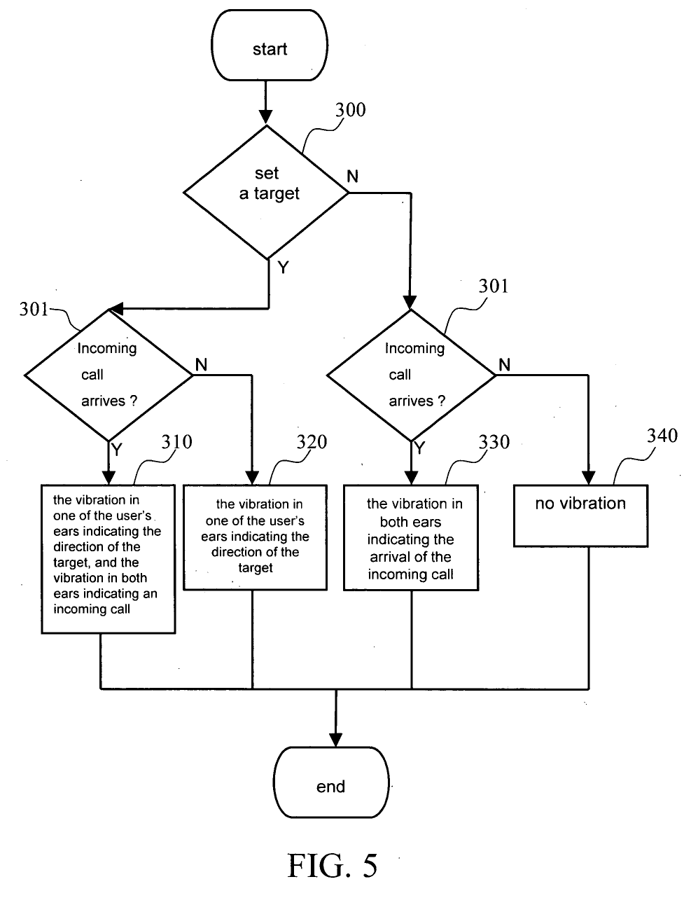

Finally, as shown in FIG. 5, it is a system flowchart indicating the steps of operation of the earphone device with vibration capability according to an embodiment of the invention. Firstly, the user sets a target of the satellite navigation system (step 300). Next, in case the incoming call arrives from the portable electronic device 10 (step 301), the vibration of the earphone device 20 in one of the user's ears is used to indicate the direction of the target, and the vibration of the earphone device in both ears is used to indicate an incoming call (step 310); in case the incoming call does not arrive from the portable electronic device 10, then the vibration of the earphone device 20 in one of the user's ears is used to indicate the direction of the target (step 320). However, if the user has not set the target of the satellite navigation system, and in this case, when an incoming call arrives (step 301), then the vibration of the earphone device in both ears is used to indicate the arrival of the incoming call (step 330). Yet, if there is no incoming call transmitted from the portable electronic device 10, then the earphone device 20 does not produce any vibration (step 340).

Therefore, the earphone device with vibration capability of the present invention may activate to generate vibrations in both of the two earphone bodies to inform the user once receiving the incoming call instruction signals, and active one of the vibration unit to generate the vibrations in the earphone body in one of the left and right ears indicating the direction of turning once receiving the navigation direction instruction signal.

Moreover, the earphone device with vibration capability may also be utilized to proceed with the signal transmission to and from the portable electronic device, by making use of a wireless transmission module, thus reminding the user of the incoming call, without being restricted by the necessity of a wire connection.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An earphone device with vibration capability applied to a portable electronic device having a satellite navigation system, comprising:
a first earphone body, including
a loudspeaker, used to produce an audio wave according to an audio signal transmitted from the portable electronic device; and
a vibration unit, used to make the earphone device vibrate according to an instruction signal transmitted from the portable electronic device;
a second earphone body, including
a loudspeaker, used to produce an audio wave according to an audio signal transmitted from the portable electronic device; and
a vibration unit, used to make the earphone device vibrate according to an instruction signal transmitted from the portable electronic device;
a signal transmission line, electrically connected to the first earphone body and the second earphone body, and is used to transmit signals; and
a connector, electrically connected to the signal transmission line, and is used to connect to the portable electronic device.

2. The earphone device with vibration capability as claimed in claim 1, wherein the vibration unit is used to generate vibrations according to an incoming call instruction signal transmitted from the portable electronic device.

3. The earphone device with vibration capability as claimed in claim 1, wherein the vibration unit is used to generate vibrations according to a navigation direction instruction signal transmitted from the portable electronic device.

4. An earphone device with vibration capability applied to a portable electronic device having a satellite navigation system, comprising:
a first earphone body, including
a loudspeaker, used to produce a sound wave according to an audio signal transmitted from the portable electronic device;
a vibration unit, used to make the earphone device vibrate according to an instruction signals transmitted from the portable electronic device;
a first processor, connected electrically to the loudspeaker and the vibration unit for receiving and transmitting signals;
a first wireless transmission module, electrically connected to the first processor for transmitting signals to and from the portable electronic device; and
a second earphone body, including
a loudspeaker, used to produce a sound wave according to an audio signal transmitted from the portable electronic device;
a vibration unit, used to make the earphone device vibrate according to an instruction signals transmitted from the portable electronic device;
a second processor, connected electrically to the loudspeaker and the vibration unit for receiving and transmitting signals; and
a second wireless transmission module, electrically connected to the second processor for transmitting signal to and from the portable electronic device.

5. The earphone device with vibration capability as claimed in claim 4, wherein the vibration unit is used to generate vibrations according to an incoming call instruction signal transmitted from the portable electronic device.

6. The earphone device with vibration capability as claimed in claim 4, wherein the vibration unit is used to generate vibrations according to a navigation direction instruction signal transmitted from the portable electronic device.
